(19) United States
(12) Patent Application Publication
(10) Pub. No.: US 2026/0247400 A1
(43) Pub. Date: Aug. 20, 2026

(54) UPLINK CODEWORD SELECTION

(71) Applicant: InterDigital Patent Holdings, Inc., Wilmington, DE (US)

(72) Inventors: Afshin Haghighat, Ile-Bizard (CA); Jonghyun Park, Syosset, NY (US); Loic Canonne-Velasquez, Dorval (CA); Moon-il Lee, Melville, NY (US); Virgil Comsa, Montreal (CA); Dylan Watts, Montreal (CA)

(73) Assignee: InterDigital Patent Holdings, Inc., Wilmington, DE (US)

(21) Appl. No.: 19/156,284

(22) PCT Filed: Feb. 9, 2024
(86) PCT No.: PCT/US2024/015157

§ 371 Date: Aug. 13, 2025

Related U.S. Application Data
(60) Provisional application No. 63/445,407, filed on Feb. 14, 2023.

(51) Int. Cl. H04W 72/232

(52) U.S. Cl. CPC H04W 72/232

(57) ABSTRACT

Systems, methods, and instrumentalities are described for dynamically determining codewords that are enabled for transmitting a transport block. A WTRU receives DCI associated with an UL grant for an UL transmission. The DCI may comprise one or more indicators associated with a first codeword and a second codeword. The one or more indicators may comprise at least one of a TPMI or an antenna-group indicator. The WTRU may determine, if the one or more indicators associated with the first codeword and the second codeword comprises a TPMI associated with the second codeword, that the first codeword is enabled for transmission and the second codeword is disabled for transmission. The WTRU transmits a transport block associated with the enabled one or more of the first codeword and the second codeword. If the first codeword is enabled, the WTRU transmits the transport block associated with the first codeword.

### CROSS-REFERENCE TO RELATED APPLICATIONS

This application claims the benefit of Provisional U.S. Patent Application No. 63/445,407, filed Feb. 14, 2023, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein that may be associated with dynamically determining a codeword that is enabled for transmitting a transport block. A wireless transmit and receive unit (WTRU) may receive downlink control information (DCI) associated with an uplink (UL) grant for an UL transmission. The DCI may comprise one or more indicators associated with a first codeword and a second codeword. The one or more indicators may comprise at least one of a transmission precoding matrix indicator (TPMI) or an antenna-group indicator. The one or more indicators may comprise at least one of a new data indicator (NDI), a redundancy version (RV), a modulation and coding scheme (MCS), or a HARQ-ID.

The WTRU may determine, based on the one or more indicators, that one or more of the first codeword and the second codeword are enabled to transmit a transport block. The WTRU may determine, based on the one or more indicators, that both the first codeword and the second codeword are enabled to transmit the transport block. The WTRU may determine, based on the one or more indicators, that one of the first codeword and the second codeword are enabled to transmit a transport block.

The WTRU may determine, based on the one or more indicators, that the first codeword is enabled for transmission and the second codeword is disabled for transmission. In examples, if the one or more indicators associated with the first codeword and the second codeword comprises a TPMI associated with the second codeword, the WTRU may determine, based on the TPMI, that the first codeword is enable for transmission and the second codeword is disabled for transmission. The TPMI associated with the second codeword may be associated with an antenna selection precoder and/or may indicate at least one of a null value, a reserved value, or a defined state.

In examples, the one or more indicators may comprise a first antenna-group indicator associated with the first codeword. The WTRU may determine, based on the first antenna-group indicator associated with the first codeword, that the first codeword is enabled for transmission.

The WTRU may transmit a transport block associated with the enabled one or more of the first codeword and the second codeword. For example, if the first codeword is enabled, the WTRU may transmit the transport block associated with the first codeword.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a flow diagram of an example for selection (enabling/disabling) of a transport block for transmission.

FIG. 3 depicts a flow diagram of an example of an ACK mechanism for two codeword transmission.

### DETAILED DESCRIPTION

A more detailed understanding may be had from the following description, given by way of example in conjunction with the accompanying drawings.

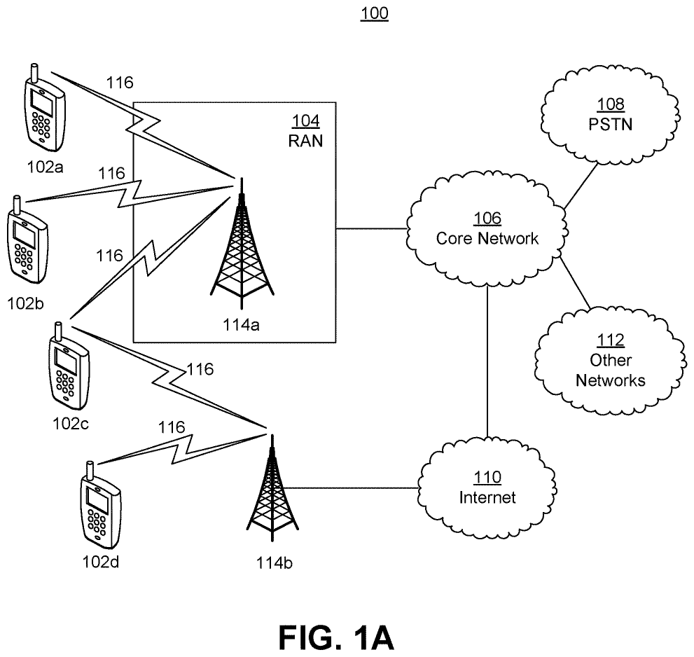

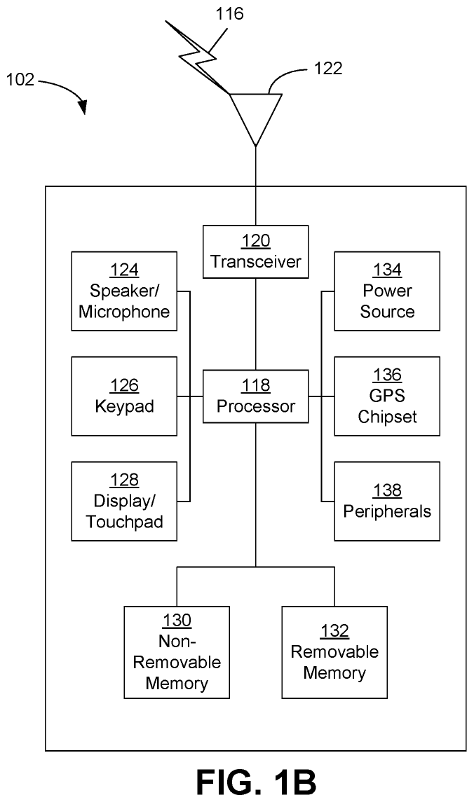

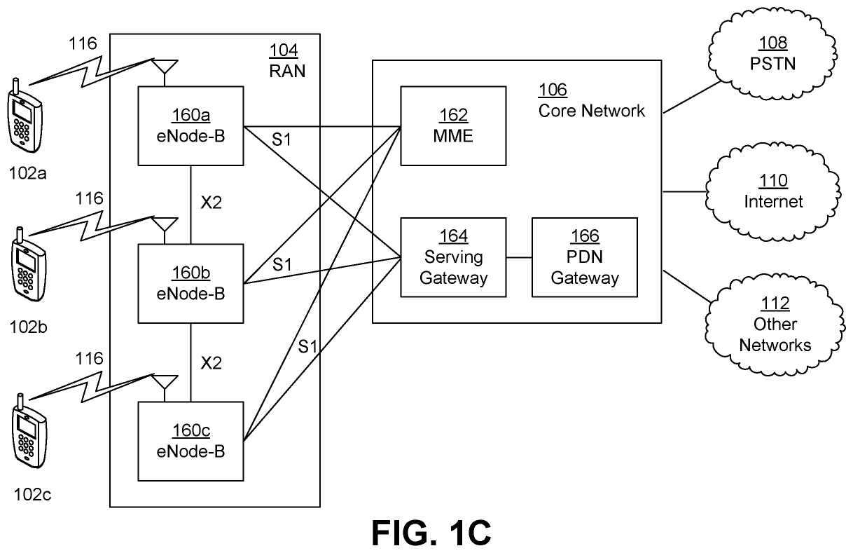

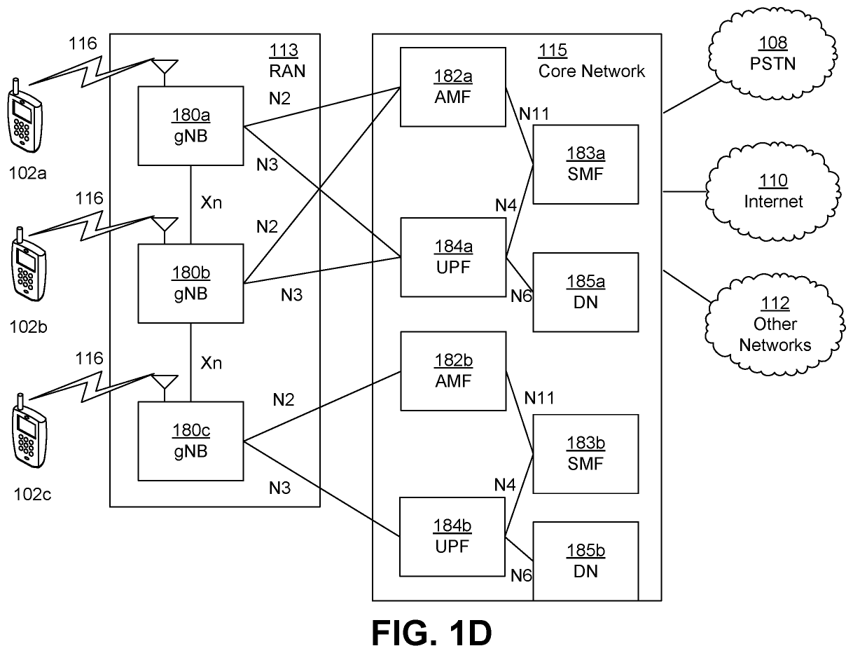

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports (e.g., only supports) a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The present application discloses systems, methods, and instrumentalities to support transmission of two or mode codewords in uplink (UL) transmissions. Implementations are disclosed for providing a modulation-and-coding-scheme (MCS) indication for a second codeword. Modes for selecting between employing the same or different MCSs are disclosed. Implementations are disclosed for dynamically enabling/disabling of a transport block. Implementations are disclosed wherein a new data indicator (NDI), redundancy version (RV), and/or CBG transmission information (CBGTI) may be employed as an indicator for two codeword transmission.

The disclosed implementations may enhance coverage, reliability, and throughput for uplink transmission. A WTRU with 8 transmitters (8TX) may support up to eight layers for uplink transmission. For an uplink transmission with rank <=4, a single codeword (CW) may be supported, while for transmissions with rank>4, dual codewords may be used. A WTRU with eight transmitters (8Tx) may support use of more than one CW, including, for example, two CW transmissions.

Disclosed herein are implementations for indicating, e.g., efficiently indicating, transmission parameters and controls for UL transmission with more than one CW. A WTRU may be configured to transmit up to four layers using a single codeword transmission. The operation of the WTRU may be limited to the use of a single CW. To support two codeword transmission in uplink transmissions, enhancements are disclosed for dynamic indication of transmission parameters and controls using, for example, UL-SCH, beta_Offset, MCS, new data indicator (NDI), redundancy version (RV), etc. One implementation may be to increase the number of such indications proportionally to the number of CWs, but such implementations may result in an increase, e.g., significant increase, in the downlink control channel. Implementations are disclosed for providing dynamic indication of transmission parameters and controls for an uplink transmission with more than one CW.

Providing MCS indication for a second codeword is disclosed. A WTRU may be configured to determine MCS for a second codeword. The WTRU may be programmed to receive an UL grant including scheduling for a transmission, e.g., a PUSCH transmission, with 2 CWs and an MCS indication.

A WTRU may determine MCS for a second codeword in one or more implementations. A WTRU may receive an UL grant including scheduling for a PUSCH transmission with two codewords and an MCS indication.

The WTRU may determine a first MCS value for a first CW and a second MCS value for a second CW based on an MCS indication which may be provided in any of several implementations. For example, the MCS indication may be used as an index or indication to a list or table (e.g., a configured or specified list or table) where each entry or row corresponds to a pair of MCS values and where one value of the pair applies to the first CW and the other value applies to the second CW.

The MCS indication may indicate a first MCS value to use for the first CW and the WTRU may determine the MCS value for the second codeword by applying a correction factor to the value for the first CW. The correction factor may be a configured value. The correction value may be updated according to the channel condition. The correction factor may be dynamically updated (e.g., by a MAC CE). The correction factor value may be indicated (e.g., by an index) in a DCI (e.g., the UL grant DCI) that may point to a value in a set of (pre) configured values. The WTRU may receive a threshold value for the correction factor to exclude certain correction factors (e.g., above or below the threshold), for example to assist decoding by an SIC receiver at gNB.

The WTRU may transmit a first UL transmission (e.g., UL-SCH or UCI) associated with the first CW based on the first MCS value (e.g., based on a first MCS determined based on the first MCS value) and may transmit a second UL transmission (e.g., UL-SCH or UCI) associated with the second CW based on the second MCS value (e.g., based on a second MCS determined based on the second MCS value).

A WTRU may be configured to select between using the same MCS or using different MCSs for the two or more codewords. To support two or more codewords, the WTRU may determine one or more MCSs to be used.

A WTRU may be configured to receive an UL grant including scheduling for a PUSCH transmission with two codewords. The UL grant may include at least one MCS indication.

The WTRU may determine a first MCS value for the first CW and a second MCS value for the second CW based on at least one of: one or more of the at least one MCS indication; WTRU antenna coherency; a number of WTRU antenna groups; whether the WTRU is scheduled for sTRP or mTRP operation or transmission; whether the WTRU is scheduled for single or multi-panel transmission; and/or receiver (e.g., gNB) decoding capability.

If the WTRU may be a fully coherent UE (e.g., fully coherent 8TX WTRU) scheduled with two codewords, the WTRU may apply the same MCS value (e.g., based on a first MCS indication in the DCI) to the first and second CWs. If the WTRU may be a partially coherent or non-coherent WTRU, the WTRU may apply different MCS values (e.g., determined based on one or more of the at least one MCS indication in the DCI) to each of the codewords.

A WTRU configured or scheduled for sTRP operation or transmission may apply the same MCS value (e.g., based on a first MCS indication in the DCI) to both CWs. If configured or scheduled for mTRP transmission, the WTRU may use different MCS values (e.g., determined based on one or more of the at least one MCS indication in the DCI) to each of the codewords.

A WTRU configured or scheduled for single panel transmission may apply the same MCS value (e.g., based on a first MCS indication in the DCI) to both CWs. If configured or scheduled for multi-panel transmission, the WTRU may use different MCS values (e.g., determined based on one or more of the at least one MCS indication in the DCI) to each of the codewords.

The WTRU may receive information, e.g., configuration information, indicating whether it supports SIC decoding and/or whether to apply the same MCS values to both CWs or different MCS values to the two CWs. For example, in the case of SIC decoding capability at gNB, the WTRU may receive an indication to apply the same MCS value to both CWs. In the case of no SIC decoding capability at gNB, the WTRU may receive an indication to apply different MCS values to the two CWs.

The WTRU may transmit a first UL transmission (e.g., UL-SCH or UCI) associated with the first CW based on the first MCS value (e.g., based on a first MCS determined based on the first MCS value) and may transmit a second UL transmission (e.g., UL-SCH or UCI) associated with the second CW based on the second MCS value (e.g., based on a second MCS determined based on the second MCS value).

A WTRU may be configured to dynamically enable and/or disable a transport block (TB). The WTRU may dynamically select a codeword (CW) or transport block (TB) for uplink transmission.

The WTRU may be configured to receive an UL grant DCI scheduling a PUSCH transmission, where the UL grant may include one or more indications associated with each of two CWs and where an indication may be an NDI, an RV, an MCS, a TPMI, a HARQ-ID, and/or an antenna-group indicator or selector.

The WTRU may determine based on at least one of the indicators that one of the CWs is enabled for transmission and the other is disabled for transmission. For example, the WTRU may determine, based on at least one of the indicators, a) to transmit a TB mapped to one of a first or second CWs of the two CWs and/or b) that transmission of a TB mapped to one of the first or second CW of the two CWs is disabled.

A TPMI indicator may be used to determine whether transmission of a TB mapped to the first or second CW may be enabled or disabled. The WTRU may receive a separate TPMI for each CW and if a value of the TPMI for a first codeword corresponds to a ‘Null,’ a reserved, or a pre-defined (TPMI=n) state, the WTRU may select (e.g., determine to transmit) a TB mapped to the second CW and may determine transmission of a TB mapped to the first CW is disabled.

A TPMI indicator may be used to determine whether transmission of a TB mapped to the first or second CW is enabled or disabled. If a WTRU receives a TPMI for a CW that corresponds to an antenna selection precoder, e.g., a precoder with a group of zero elements, the WTRU may determine that the CW is disabled.

An antenna-group indicator or selector may indicate a codeword (e.g., the first or second CW) for the scheduled transmission.

The WTRU may transmit a TB mapped to the first CW or the second CW based on the determination of which CW is enabled and which is disabled, where the transmission may be based on at least one indicator associated with the CW used for transmission.

NDI, RV and CBGTI may be employed as indicators for two codeword transmission. A WTRU may be configured to use, e.g., use a single, NDI, RV, and/or CBGTI indicator for two codeword transmission.

A WTRU may transmit a first PUSCH transmission with two CWs. The WTRU may receive an UL grant DCI scheduling a second PUSCH transmission, where the UL grant may include one or more indications associated with each of two CWs and where an indication may be an NDI, an RV, and/or a CBGTI.

The WTRU may determine whether to retransmit the first and/or second CW based on at least an (e.g., one) NDI included in the DCI. If the NDI is toggled (e.g., compared to a last grant received for the same HARQ process), the WTRU may determine that the TBs mapped to both CWs of the first transmission were received successfully and to transmit new data for both CWs. If the NDI is not toggled, the WTRU may determine (e.g., interprets that as an indication) to retransmit the CW with a lower MCS (e.g., the lower MCS used for the first PUSCH transmission or the lower MCS indicated in the DCI for the second PUSCH transmission). If the NDI is not toggled, the WTRU may determine whether to retransmit the second CW based on a combination of one or more other received indications in the DCI, e.g., a combination of one or more of RV, CBGTI, or others.

The WTRU may, e.g., may optionally, interpret a received RV according to a dynamic or semi-static configuration in which a table is configured wherein each received RV index in the DCI points to a pair of RV values that correspond to the first and second codewords. For retransmission of a single codeword, the first value, e.g. only the first value, of the indicated pair may be used.

If retransmission may be determined to apply for at least one CW, the WTRU may retransmit a TB mapped to each of the CWs that may be determined to be retransmitted. The WTRU may retransmit codeblocks (e.g., for one or both CWs) based on the CBGTI.

If new data transmission may be determined for at least one CW, the WTRU may transmit a new TB mapped to each CW for which it was determined to transmit new data.

As noted herein, MCS indication may be provided for the second codeword. The WTRU may be programmed to determine MCS for the second codeword.

A WTRU may receive an UL grant including scheduling for a PUSCH transmission with two CWs and an MCS indication. The WTRU may determine a first MCS value for the first CW and a second MCS value for the second CW based on the MCS indication. The MCS indication may be used as an index or indication to a list or table (e.g., a configured or specified list or table) where each entry or row corresponds to a pair of MCS values, where one value of the pair applies to the first CW and the other value applies to the second CW. The MCS indication may indicate a first MCS value to use for the first CW and the WTRU may determine the MCS value for the second codeword by applying a correction factor to the value for the first CW. The correction factor may be one or more of the following: the correction factor may be configured; the correction value may be updated according to the channel condition; the correction factor may be dynamically updated (e.g., by a MAC CE); the correction factor value may be indicated (e.g., by an index) in a DCI (e.g., the UL grant DCI) that may point to a value in a set of (pre) configured values; the WTRU may receive a threshold value for the correction factor to exclude certain correction factors (e.g., above or below the threshold), for example, to assist decoding by an SIC receiver at a base station, e.g., gNB.

The WTRU may transmit a first UL transmission (e.g., UL-SCH or UCI) associated with the first CW based on the first MCS value (e.g., based on a first MCS determined based on the first MCS value) and may transmit a second UL transmission (e.g., UL-SCH or UCI) associated with the second CW based on the second MCS value (e.g., based on a second MCS determined based on the second MCS value).

An MCS field (e.g., a 5-bit length MCS field) may be used to indicate a modulation and coding scheme for the scheduled transmission of one codeword. For an eight transmitter (8TX) WTRU scheduled for transmission with two codewords, one or more of the following WTRU behaviors may be used: WTRU, e.g., UE, behavior 0; and WTRU, e.g., UE, behavior 1. If WTRU behavior 0 is employed, the WTRU may use the same available MCS field (e.g., 5-bits) and apply the MCS on both codewords. If WTRU behavior 1 is employed, the WTRU may employ the same available MCS field (e.g., 5-bits), and a modified new MCS table where each row may represent a pair of MCS values. The WTRU may determine the MCS for the second codeword by applying a correction factor to the value read from the configured table. The correction factor may be updated according to the channel condition. The correction factor may be dynamically updated by a MAC CE. The correction factor value may be indicated, e.g., may alternatively be indicated, by an index in a DCI that may point to a set of pre-configured values.

The WTRU may receive a threshold value for the correction factor to exclude certain correction factors to assist decoding by an SIC receiver at a base station, e.g., gNB.

If WTRU behavior 2 applies, the WTRU may select the mode of operation according to one or more of the following. In the case of Option 2.a, WTRU antenna coherency (Antenna grouping, Ng=1, 2 or 4), a fully coherent 8TX WTRU scheduled with two codewords may apply the same MCS value, but a partially/non-coherent WTRU may apply different MCS values on each codeword. In the case of Option 2.b: STRP or mTRP operation, a WTRU scheduled for sTRP may apply the same MCS value, but if configured for mTRP transmission, the WTRU may use different MCS values on each codeword. In the case of Option 2.c: Single panel or multi-panel WTRU transmission (one or more SRS resource sets), a WTRU scheduled for a single panel transmission may apply the same MCS, but if configured for multi-panel transmission may apply different MCS values. In the case of Option 2.d: Based on gNB decoding capability, if the base station, e.g., gNB, is capable of SIC decoding, it may configure a WTRU to use one behavior instead of another. For example, in case of SIC decoding capability at gNB, the WTRU may receive an indication to adopt WTRU behavior 0. Otherwise, a WTRU may indicate MCS for the second codeword using other behaviors such as, for example, behavior 1 or 2.

A WTRU may determine two MCSs as a function of a single field in a DCI. In examples, a WTRU may receive a grant where one field may indicate more than one MCS value. The field may correspond to a sequence of bits which maps to a table of MCS indices indicating one modulation order and coding rate per CW. The field may reuse the existing MCS indicator field, and a WTRU may map the field to the two CW MCS table. The new table may be preconfigured for the two CW case (e.g., mcs-Table-dualCW), and the WTRU may receive the table as part of the information, e.g. configuration information, for the PUSCH, PUSCH-Config. One or more of the following implementations may be considered.

In implementations, a WTRU may receive information, e.g., configuration information, with two different MCS tables, where one table applies for the single CW case, and a second table (mcs-Table-dualCW) for the two CW case. A WTRU may dynamically determine to use the single or two CW table as a function of a grant indicating a resource allocation for one or two CW.

In implementations, a WTRU may receive information, e.g., configuration information, with a single MCS table, and each row may either indicate one MCS value, or a pair of MCS values. A WTRU may receive an MCS indication which maps to a subset of table rows, and the WTRU may determine the subset as a function of the number of scheduled CWs. For example, a WTRU may receive a configured table with 4 rows where the first two rows are for single CW, and the next 2 entries are for dual CW (e.g., each entry points to a pair of modulation rates). If a WTRU receives a grant for single CW scheduling and one bit for MCS indication, the WTRU may determine that the 1 bit indicates MCS selection between the first two entries subset. If a WTRU receives a grant for dual CW scheduling and one bit for MCS indication, the WTRU may determine that the 1 bit indicates MCS selection between the last two entries subset.

In implementations, a WTRU may receive information, e.g., configuration information, with a single MCS table for two CWs, and a WTRU may determine to use one or two MCS/coding rates as a function of the number of scheduled CWs. If a WTRU determines that single CW scheduling is used, then a WTRU may select the first MCS/coding rate from the pair of MCS/coding rates configured in the MCS table. If a WTRU determines that two CWs scheduling is used, then a WTRU may select both from the pair.

In Table 1, each row may indicate a single modulation order and target code rate to achieve a given spectral efficiency. A WTRU may receive the MCS index in 5-bit representation in a grant and may determine one MCS for one CW. Table 2 is an example MCS indication table, wherein each row may indicate a pair of MCSs. For example, index 0 may indicate the pair of modulation orders (2,2), where the first element of the pair may be applied to the first CW, the second element of the pair may be applied to the second CW, and the pair of target code rates may be mapped to the CWs. With Index 27, a WTRU may determine two different modulation orders for the two CWs and their respective code rates.

TABLE 1
Exemplary Rel-17 MCS index table with
single codepoint indicating single MCS

| MCS Index | Modulation | Target code | Spectral |
|---|---|---|---|
| I_{MCS} | Order Qₘ | Rate R × 1024 | efficiency |
| 0 | q | 240/q | 0.2344 |
| 1 | q | 314/q | 0.3066 |
| 2 | 2 | 193 | 0.3770 |
| . . . | . . . | . . . | . . . |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

TABLE 2
Proposed new MCS mapping table with single
codepoint indicating an MCS pair

| MCS Index | Modulation | Target code | Spectral |
|---|---|---|---|
| I_{MCS} | Order Qₘ | Rate R × 1024 | efficiency |
| 0 | (2, 2) | (193, 308) | (0.3770, 0.6016) |
| . . . | . . . | . . . | . . . |
| 27 | (6, 2) | (948, 193) | (5.5547, 0.3770) |

| | | |
|---|---|---|
| 28 | q | Reserved |
| 29 | 2 | reserved |
| 30 | 4 | reserved |
| 31 | 6 | reserved |

A WTRU may determine a mapping from the MCS pair to a set of parameters other than the CW indices. A WTRU may receive an MCS mapping table such as Table 2 where one row may indicate a pair of MCSs, and a WTRU may determine the association between each MCS in the pair and one parameter/capability of a WTRU. The association may be preconfigured, or different tables may be configured for different associations. One or more of the following associations may be considered: a WTRU may determine that the first MCS may be associated with a first WTRU panel, and the second MCS may be associated with a second WTRU panel; a WTRU may determine that the first MCS may be associated with transmission/reception from a first TRP index, and the second MCS may be associated with transmission/reception from a second TRP index; a WTRU may determine that the first MCS may be associated with transmission/reception from a first antenna port group, and the second MCS may be associated with transmission/reception from a second antenna port group.

A WTRU may determine two MCSs from a single MCS indication and a correction factor. A WTRU may receive in a grant a single MCS indication and a correction factor. A WTRU may determine an MCS for a first CW based on the MCS indication, and an MCS for a second CW as a function of the MCS indication and the correction factor. The correction factor may be configured as an integer. In an example, a WTRU may be indicated a correction factor dynamically, e.g., a MAC CE, DCI, etc., or semi-static via RRC signaling. The WTRU may receive a table with one correction factor configured per row. A WTRU may receive in the grant an indication to one of the rows of the correction factor table. For example, the MCS indication may point to index n in an MCS table such as Table 1, and the correction factor may indicate an integer k. If the WTRU determines that two CWs are scheduled, the WTRU may apply MCS from row n to the first CW, and the MCS from row (n+k) to the second CW.

A WTRU may be configured with a single correction factor table and may receive a MAC-CE to update one or multiple rows of the correction factor table. A WTRU may be configured, e.g., may alternatively be configured, with a set of multiple correction factor tables and the MAC-CE may activate one correction factor table from the set of correction factor tables.

A delta or differential indication of a correction factor may be provided. A WTRU may receive, e.g., via an RRC, a MAC-CE, or a second DCI, more than one correction factor (having a limited value range configurable by a gNB) prior to receiving the grant. The WTRU may determine a second MCS for the second CW based on the MCS indication by the grant and one correction factor (being indicated or selected) of the more than one correction factors, e.g., that are configured with the limited value range (e.g., via a delta or differential indication) within a possible value range from the MCS indication.

The more than one correction factors may be {−5, −4, −3, −2, −1, 0, 1, 2}, e.g., as candidate values for k, which may be further indicated or selected by a 3-bit selector (or field, e.g., in the grant). The more than one correction factors may be {−2, −1, 0, 1}, e.g., as candidate values for k, which may be further indicated or selected by a 2-bit selector (or field, e.g., in the grant).

The WTRU may receive in the grant a first MCS indication and a correction factor, e.g., by a second field (2-bit field) selecting one among {−2, −1, 0, 1}. The WTRU may determine a first MCS for a first CW based on the first MCS indication (e.g., pointing to index n in an MCS table such as Table 1), and a second MCS for a second CW based on the determined index n (by the first MCS indication) and the correction factor. The WTRU may determine that the correction factor is k (e.g., k=−1), e.g., indicated by the second field (2-bit field). In response, the WTRU may determine the second MCS for the second CW based on pointing to index n+k, which may be n-1. This may mean that the determined second MCS may be one level (e.g., index) lower than the first MCS. This may provide benefits in terms of signaling overhead reduction or saving on dynamic selection for the correction factor among the limited candidates correction factors (e.g., up to 8 for the 3-bit selector example, or up to 4 for the 2-bit selector example), e.g., based on a determined property that the usage of two CWs (instead of 1 CW) may come from a small or limited MCS-level (e.g., MCS-index) difference between the first MCS and the second MCS.

The WTRU may determine that the determined index n+k (of an MCS table) may be pointing to an invalid, not defined, or not-valid index (e.g., a negative integer value, or an out-of-range value, etc.). In response to the determining, the WTRU may determine a second index (of the MCS table) that may be closest to the determined index n+k, and, by applying, using, or based on the second index, may determine the second MCS for the second CW. The second index may be a shifted index from the determined index n+k to be a valid index in the MCS table, e.g., where the second index may be a low, e.g., a lowest, index or a high, e.g., highest, index of the MCS table, e.g., except an out-of-range index.

The WTRU may determine that the indicated index n is 1 and the correction factor is k (e.g., k=−2), e.g., indicated by the second field (2-bit field). In response to the determining, the WTRU may determine the second MCS for the second CW based on pointing to index n+k, which may be n-2=−1. The WTRU may determine that the determined index n+k (=−1) may not be a valid index of the MCS table, may determine a second index that may be 0 which is a closed valid index from the determined index −1, and by applying, using, or based on the second index of 0, may determine the second MCS for the second CW.

Modes of operation may be employed for selecting between same or different MCSs. A WTRU may be configured to determine one or more MCSs to be used.

A WTRU may receive an UL grant including scheduling for a PUSCH transmission with two CWs, where the UL grant may include at least one MCS indication.

A WTRU may determine a first MCS value for the first CW and a second MCS value for the second CW based on at least one of the following: one or more of the at least one MCS indication; WTRU antenna coherency; number of WTRU antenna groups; whether the WTRU may be scheduled for sTRP or mTRP operation or transmission; whether the WTRU may be scheduled for single or multi-panel transmission; and/or receiver (e.g., gNB) decoding capability.

If the WTRU may be a fully coherent WTRU (e.g., fully coherent 8TX UE) scheduled with two codewords, the WTRU may apply the same MCS value (e.g., based on a first MCS indication in the DCI) to the first and second CWs. If the WTRU may be a partially coherent or non-coherent WTRU, the WTRU may apply different MCS values (e.g., determined based on one or more of the at least one MCS indication in the DCI) to each of the codewords.

A WTRU configured or scheduled for sTRP operation or transmission may apply the same MCS value (e.g., based on a first MCS indication in the DCI) to both CWs. If configured or scheduled for mTRP transmission, the WTRU may use different MCS values (e.g., determined based on one or more of the at least one MCS indication in the DCI) for each of the codewords.

A WTRU configured or scheduled for single panel transmission may apply the same MCS value (e.g., based on a first MCS indication in the DCI) to both CWs. If configured or scheduled for multi-panel transmission, the WTRU may use different MCS values (e.g., determined based on one or more of the at least one MCS indication in the DCI) for each of the codewords.

The WTRU may receive information, e.g., configuration information, indicating whether it supports SIC decoding and/or whether to apply the same MCS values to both CWs or different MCS values for the two CWs. In case of SIC decoding capability at the base station, e.g., gNB, the WTRU may receive an indication to apply the same MCS value to both CWs. In case of no SIC decoding capability at the base station, e.g., gNB, the WTRU may receive an indication to apply different MCS values to the two CWs.

The WTRU may transmit a first UL transmission (e.g., UL-SCH or UCI) associated with the first CW based on the first MCS value (e.g., based on a first MCS determined based on the first MCS value) and may transmit a second UL transmission (e.g., UL-SCH or UCI) associated with the second CW based on the second MCS value (e.g., based on a second MCS determined based on the second MCS value).

A single panel or multi-panel WTRU transmission (one or more SRS resource sets) may be employed to determine one or more MCSs. A WTRU with a multi panel transmission capability may report the coherence properties of its transmission frontend. These capabilities may be used to define the supported codebook-based transmissions. These coherence properties may take the form of “noncoherent,” “partialAndNonCoherent,” and/or “fullyAndPartialNonCoherent.”

The WTRU may determine its codebook transmission subsets based on TPMI and related to its higher layer parameter configured for PUSCH semi-static parameters that may be associated with DCI formats 0_1 and 0_2 respectively that may be related to the coherence reported capabilities of the WTRU.

If a WTRU has only one panel capability, then a single SRS resource set may be configured, and thus PUSCH may be transmitted over the same ports. The WTRU may use for all PUSCH layers the same MCS.

A multi-panel capable WTRU may report partial and/or non-coherent or a combination for Tx frontend capability. This declaration may be interpreted by the network as per panel or panel group coherency and inter-panel or inter-panel group non-coherency for example. In terms of power capability versus panel this may be interpreted as full power capability per panel or panel group.

For the multi-panel WTRU the multi-panel coherence capability versus fullPowerMode and SRS resource sets that may be associated may be interpreted as follows: noncoherent;

fullyAndPartialNonCoherent; and partialAndNonCoherent.

With respect to noncoherent, the WTRU may support a single SRS resource set and maximum 4 layers PUSCH and a single CW and single MCS.

With respect to fullyAndPartialNonCoherent, all panels may be coherent or at least two coherent panels or sub-groups panels. fullyAndPartialNonCoherent may support eight layers with a single MSC over multiple panels or group of panels that may be coherent and the WTRU may be configured with either fullPowerMode 1 and/or a single set of SRS resource set. In this case, two CWs may be split over a first panel or panel group with four layers and a first CW and the rest of PUSCH layers to a second panel or panel group with the same MSC. If configured with fullPowerModel 2, and two SRS resource sets, the first PUSCH 4 layers may be mapped to a first panel or group of panels that are coherent and the rest of the layers to a second panel or group of panels corresponding to the second SRS resource set. The MCS for the first and the second panels or panel groups may be different in this case.

With respect to partialAndNonCoherent, at least 2 panels or groups of panels may be noncoherent, but the panel or the panels sub group are individually coherent. In this case, the WTRU behavior may be as follows. If the WTRU is configured with fullPowerMode 1, then a single SRS resource set may be expected and then a 4 layers PUSCH limit may be applied with a single MCS all mapped to the same panel or coherent panel group. If the WTRU may be configured with fullPowerMode 2, then two SRS resource sets may be expected to be configured and then the first PUSCH 4 layers may be mapped to a first panel or group of panels that are coherent and the rest of the layers to a second panel or group of panels corresponding to the second SRS resource set. The MCS for the first and the second panels or panel groups may be different in this case.

As the number of layers per panel or panel group may be different, if the same MCS is applied, the PUSCH power may still be, e.g., have to be, equally split between the allocated antenna ports over both panels or panel groups.

If the MCS is different, namely MCS1 and MCS2, due to possible different MPR over two panels or panel groups, namely MPR1 and MPR2 respectively, the WTRU may use overall the equation, MPR=Max {MPR1, MPR2}, for the definition of the maximum configured power for UL MIMO case with two MCS case.

For MCS level indication for a second codeword, one or more modes of operation may be used, wherein the modes of operation may include at least one of following. A 5-bit single MCS field may be used and the same MCS value may be applied or used for both codewords. A 5-bit single MCS field may be used and each codepoint of MCS field may indicate a pair of MCS values. A new MCS table may, e.g., may alternatively, be used, wherein each row in the new MCS table may represent a pair of MCS values. A 5-bit single MCS field may be used and an indicated MCS value may be used for a first codeword and a correction value may be applied to a second codeword, wherein the correction value may be predetermined, configured, or indicated. A second MCS field (e.g., 5bits) may be included in the DCI, wherein each MCS field in the DCI may be associated with a codeword independently. An MCS offset field (e.g., <5bits) may be included in the DCI, wherein the MCS offset field may indicate an MCS level of a second codeword based on the MCS level of a first codeword as an offset.

A mode of operation for MCS indication may be determined based on WTRU antenna coherency. A WTRU may determine a mode of operation for MCS indication based on the WTRU's antenna capability. For example, if a WTRU may be equipped with fully coherent antennas (or a WTRU reported its fully coherent antennas capability), the WTRU may determine a first mode of operation (e.g., same MCS for both codewords) for MCS indication for a second codeword; while the WTRU may determine a second mode of operation (e.g., independent MCS indication for a second codeword) if the WTRU is equipped with partially coherent antennas or non-coherent antennas (or a WTRU reported its partially coherent or non-coherent antennas capability). One or more of following may apply: gNB may indicate a mode of operation determined based on the WTRU capability report for the WTRU antenna coherency; and a subset of operation modes may be determined based on the WTRU antenna coherency and the gNB may indicate an operation mode within the subset of operation modes determined.

A mode of operation for MCS indication may be determined based on gNB receiver capability. An operation mode for MCS indication may be determined based on gNB receiver capability. For example, a first mode of operation may be used for a first gNB receiver type and a second mode of operation may be used for a second gNB receiver type. One or more of following may apply: a first mode of operation (e.g., same MCS applied for both codewords) may be used or determined if a gNB is equipped with a first type of receiver (e.g., MMSE type of receiver); a second mode of operation (e.g., MCS offset, independent MCS level indication) may be used or determined if a gNB is equipped with a second type of receiver (e.g., SIC type of receiver); and the receiver type for a gNB may be indicated or informed to a WTRU. The receiver type for the gNB may be indicated or informed to the WTRU based on at least one of the following: an index associated with an operation mode or a group of operation modes; a receiver type indicator which may be provided via a higher layer signaling (e.g., MIB, SIB, RRC, and/or MAC-CE); and/or an offset value between a first MCS value and a second MCS value, wherein the first MCS value may be associated with a first codeword and the second MCS value may be associated with a second codeword.

A mode of operation for MCS indication may be determined based on transmission scheme used for uplink. A mode of operation for MCS indication may be determined based on a transmission scheme used for uplink transmission. For example, if a first type of transmission scheme (e.g., closed-loop MIMO scheme) may be used, configured, or determined, a first mode of operation (e.g., independent MCS indication) may be used; if a second type of transmission (e.g., open-loop MIMO scheme) may be used, configured, or determined, a second mode of operation may be used. One or more of the following may apply. Closed-loop MIMO scheme, which may be referred to as a MIMO scheme, may use, e.g., may require, a feedback information related to antennas (e.g., PMI). Closed-loop MIMO scheme may use a dynamic indication of precoding vectors/matrices. Open-loop MIMO scheme, which may be referred to as a MIMO scheme, may not require or use feedback information related to antennas, while open-loop MIMO scheme may still require a WTRU to report CQI and RI information, and open-loop MIMO scheme may use a pre-determined precoding vector(s)/matrix (cies). MIMO transmission scheme type may be determined based on reference signal type for demodulation, wherein reference signal type may be determined based on one or more of following: reference signal type may be determined based on reference signal pattern (e.g., time/frequency density, time/frequency location, OCC, etc.); and reference signal type may be determined based on whether the reference signal is precoded or not (e.g., a precoded reference signal may be referred to as DM-RS and non-precoded reference signal may be referred to as CRS). A WTRU configured for MIMO transmission may further be indicated to operate for transmission to one or more TRP. Base on the indicated operation, a WTRU may determine whether a same MCS or different MCS is to be applied for its uplink transmission. In examples, if a WTRU may be configured and scheduled for transmission to one TRP, the WTRU may apply the same MCS value on both codewords. However, if it may be configured and scheduled for transmission to more than one TRP, the WTRU may apply different MCS for each codeword.

A mode of operation for MCS indication may be determined based on sTRP or mTRP operation. A mode of operation for MCS indication may be determined based on determining an sTRP or mTRP transmission scheme, which may be indicated dynamically based on a (scheduling) grant (e.g., a UL-DCI). The grant may indicate toward how many TRPs (e.g., transmission and/or reception configurations or points) a WTRU may be scheduled to transmit an uplink signal (e.g., PUSCH), e.g., which may be indicated via a DCI field (e.g., an SRS resource set indicator field).

If a single TRP (sTRP) may be indicated, e.g., via the DCI field, a first mode of operation (e.g., applying the same MCS value) may be used. If a multi TRP (mTRP) may be indicated, e.g., via the DCI field, a second mode of operation (e.g., applying different MCS values on each codeword) may be used. The WTRU may apply at least one implementation discussed herein (throughout the disclosure) for applying different MCS values on each codeword based on the second mode of operation.

The WTRU may determine more than one mTRP scheme that may be selected for transmitting the uplink signal (e.g., dynamically selected via the grant, etc.). The more than one mTRP schemes may comprise at least one of following: STxMP-SDM: Simultaneous Tx from multi-panels (STxMP) spatial domain multiplexing (SDM); STxMP-SFN: Simultaneous Tx from multi-panels (STxMP) single frequency network (SFN) transmission; and so forth.

The WTRU may receive an explicit configuration, e.g., configuration information, or indication (or an implicit rule or determination) which associates one scheme of the more than one mTRP schemes with one of the first mode of operation and the second mode of operation. STxMP-SFN may be associated with the first mode of operation, and STxMP-SDM may be associated with the second mode of operation, e.g., based on the explicit configuration or indication from a gNB, or based on an implicit rule or determination.

If a multi TRP (mTRP) scheme may be indicated, e.g., via the DCI field, and when determining the mTRP scheme may be STxMP-SFN, a first mode of operation (e.g., applying the same MCS value) may be used. If a multi TRP (mTRP) scheme may be indicated, e.g., via the DCI field, and if determining the mTRP scheme may be STxMP-SDM, a second mode of operation (e.g., applying different MCS values on each codeword) may be used. The WTRU may apply at least one implementation discussed herein (throughout the disclosure) for applying different MCS values on each codeword based on the second mode of operation.

Dynamic Enabling/Disabling of a transport block may be provided. A WTRU may be configured to dynamically select a codeword (CW) or transport block (TB) for uplink transmission.

A WTRU may receive an UL grant DCI scheduling a PUSCH transmission, where the UL grant may include one or more indications associated with each of two CWs and where an indication may be an NDI, an RV, an MCS, a TPMI, a HARQ-ID, and/or an antenna-group indicator or selector.

A WTRU may determine based on at least one of the indicators that one of the CWs is enabled for transmission and the other is disabled for transmission. The WTRU may determine, based on at least one of the indicators, a) to transmit a TB mapped to one of a first or second CW of the two CWs and/or b) that transmission of a TB mapped to one of the first or second CW of the two CWs is disabled. A TPMI indicator may be used to determine whether transmission of a TB mapped to the first or second CW is enabled or disabled. The WTRU may receive a separate TPMI for each CW and if a value of the TPMI for a first codeword corresponds to a ‘Null’, a reserved, or a pre-defined (TPMI=n) state, the WTRU may select (e.g., determine to transmit) a TB mapped to the second CW and may determine transmission of a TB mapped to the first CW is disabled. A TPMI indicator may be used to determine whether transmission of a TB mapped to the first or second CW is enabled or disabled. If a WTRU receives a TPMI for a CW that corresponds to an antenna selection precoder, e.g., a precoder with a group of zero elements, the WTRU may determine that the CW is disabled. An antenna-group indicator or selector may indicate a codeword (e.g., the first or second CW) for the scheduled transmission.

A WTRU may transmit a TB mapped to the first CW or the second CW based on the determination of which CW is enabled and which is disabled, where the transmission may be based on at least one indicator associated with the CW used for transmission.

For an 8TX WTRU configured with two codewords uplink transmission, one or more of the following may be used for disabling one of the transport blocks: WTRU behavior 1; WTRU behavior 2; and/or WTRU Behavior 3.

With respect to WTRU behavior 1, a WTRU may use a combination of one or more of DCI fields, e.g., NDI, RV, MCS, TPMI, HARQ-ID, etc., to disable a transport block.

With respect to WTRU behavior 2, a WTRU may indicate a specific TPMI or range of TPMI as an indication. In WTRU behavior 2.a, the WTRU may be indicated an antenna selection precoder such as the following: [x_1 x_2 x_3 x_4 0 0 0 0] to indicate transmission of the second transport block mapped on the second CW may be disabled; and/or [0 0 0 0 x_1 x_2 x_3 x_4] to indicate transmission of the first transport block mapped on the second CW may be disabled, where x_i=+/−1 or 0 and not all x_i=0.

With respect to WTRU behavior 2.b, the WTRU may be indicated an antenna selection precoder such as the following: [x_1 x_2 x_3 x_4 0 0 0 0] to indicate transmission of the second transport block mapped on the second CW is disabled; and/or [0 0 0 0 x_1 x_2 x_3 x_4] to indicate transmission of the first transport block may be disabled, but the remaining transport block may now be mapped on the first codeword and the TPMI may be corrected as [x_1 x_2 x_3 x_4 0 0 0 0], where x_i=+/−1 or 0 and not all x_i=0.

With respect to WTRU behavior 3, a WTRU may receive an indication of a specific antenna group. For example, a WTRU may be explicitly or implicitly indicated by a dynamic indication field to disable a transmission of a transport block corresponding to a specific antenna group. A WTRU may transmit the remaining transport block using the antenna group associated with the first codeword.

For downlink (DL) transmission, if the higher layer parameter maxNrofCodeWordsScheduledByDCI in PDSCH-config indicates that two codeword transmission may be enabled, then one of the two transport blocks may be disabled by DCI format 1_1 if IMCS=26 and if rvid=1 for the corresponding transport block.

A WTRU may receive scheduling information to transmit two transport blocks or two codewords. A WTRU may be indicated to transmit more than one codewords based on one or more of the following. A WTRU may indicate implicitly or explicitly its capability to support transmission with more than two codewords. For example, a WTRU may indicate such capability by a specific indication, e.g., UL2codeword. Or alternatively, it may, for example, indicate its capability implicitly by indicating one or more of maximum uplink transmission rank, number of transmit antennas, number of antenna groups, etc. As an example, if a WTRU may indicate support of a maximum rank of 8, a gNB may assume that the WTRU might also support uplink transmission with more than two codewords.

A WTRU may be indicated to transmit more than one codewords based on, if the WTRU may have the capability of support of more than one codewords, the WTRU may receive an indication to expect future scheduling to be based on two codeword transmission. The indication to activate or deactivate transmission with two codewords, may be signaled by an RRC configuration, MAC-CE, DCI or a combination thereof. The uplink transmission with more than two codewords may be activated for a specific period of time that may be configured or indicated separately.

If a WTRU may be configured to operate with more than one codeword, e.g., two codewords, for its uplink transmission, the WTRU may receive a dynamic indication to determine how many and which codewords to transmit. The dynamic indication may be included in the DCI scheduling the uplink transmission. The DCI-based dynamic indication for determination of the codewords for transmission may be carried out explicitly or implicitly. Dynamic determination of the codeword for transmission may be used in connection with a WTRU that may determine if one, e.g., only one, of the codewords may be selected for transmission based on whether a specific field is configured in the uplink scheduling DCI. The specific field may be a new 1-bit length DCI, or re-use of some other existing field. If the WTRU determines that the field is not configured for the uplink scheduling DCI, the WTRU may interpret that both codewords may be selected for uplink transmission. If the field, e.g., the 1-bit length DCI, may be configured, a WTRU may determine which of the codewords may be selected for transmission according to the state of the field. For example, an indicated state ‘0’ may indicate selection of the first codeword, while an indicated state of ‘1’ may indicate selection of the second code word.

Dynamic determination of the codeword may be used in connection with a WTRU that may use a combination of one or more of the uplink DCI fields, e.g., NDI, RV, MCS, TPMI, HARQ ID, etc., to determine whether transmission of a codeword may be selected for transmission. A WTRU may determine selection of a codeword for transmission based on combinations of indicated NDI and HARQ-ID associated with the codeword. If NDI of a first codeword may be toggled, e.g., the previous uplink was successful, and the HARQ-ID of the first codeword may be the same as the last transmission, a WTRU may interpret this state as an indication to select the second codeword for transmission.

Dynamic determination of the codeword may be used in connection with a WTRU that may determine the selected codeword for transmission based on the received TPMI or TPMIs corresponding to the codeword. A WTRU may receive a scheduling DCI that may include more than one TPMI where each TMPI may correspond to a different codeword. If a WTRU may receive a DCI containing a TPMI for a first codeword that may correspond to a ‘Null,’ a reserved or a pre-defined (TPMI=n) state, a WTRU may select the second codeword for transmission using the second received TPMI. A WTRU may receive a single TPMI for transmission of more than one codeword. If a WTRU receives a TPMI that corresponds to an antenna selection precoder, e.g., a precoder with zero element, a WTRU may determine selection of the codeword for transmission according to the structure of the received TPMI. If a WTRU may receive a TPMI corresponding to an antenna selection precoder, such as [x_1 x_2x_3 x_4 0 0 0 0], the WTRU may select the first codeword for the scheduled transmission. If a WTRU may receive, e.g., may alternatively receive, a TPMI corresponding to an antenna selection precoder, such as [0 0 0 0 x_1 x_2 x_3 x_4], the WTRU may select the second codeword for the scheduled uplink transmission. Some but not all x_i may be zero. If a WTRU may receive a TPMI corresponding to an antenna selection precoder, such as [x_1 x_2 x_3 x_4 0 0 0 0], the WTRU may select the first codeword for the scheduled transmission. If a WTRU may receive, e.g., may alternatively receive, a TPMI corresponding to an antenna selection precoder, such as [0 0 0 0 x_1 x_2 x_3 x_4], the WTRU may select the transport block associated with the second codeword for the scheduled uplink transmission, but for transmission, it may map the selected transport block on the first codeword, by re-interpreting the precoder as [x_1 x_2 x_3 x_4 0 0 0 0]. Some but not all x_i may be zero.

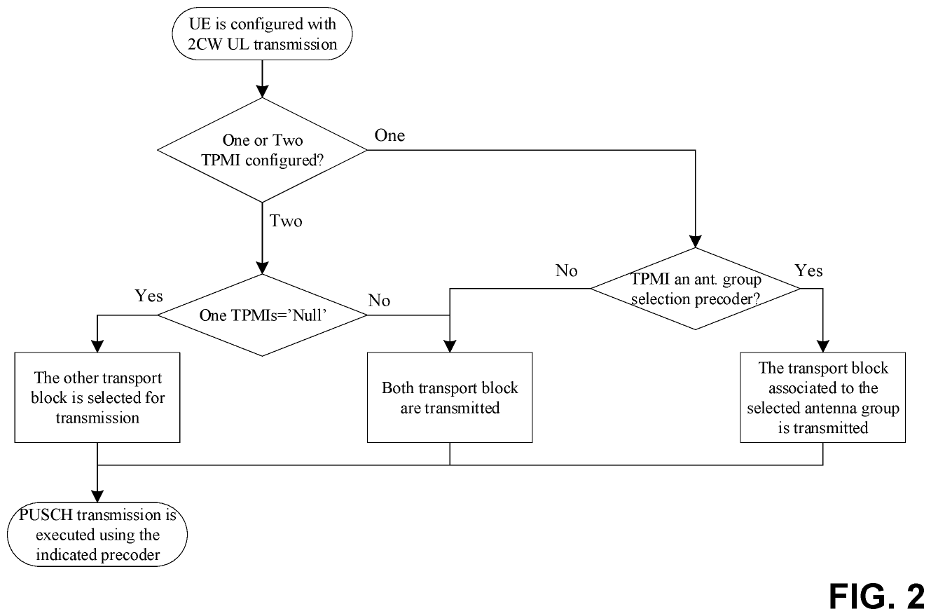

FIG. 2 depicts an exemplary implementation for selection (enabling/disabling) of a transport block for transmission based on the indicated TPMIs. A WTRU may have Ng antenna groups for uplink transmission, where for a scheduled uplink transmission, each transport block may be associated with a different antenna group. A WTRU may receive one or more TPMI indications for precoding of the scheduled transmission. If a WTRU receives an uplink scheduling DCI, e.g., DCI format 0_1, the WTRU may also receive an implicit or explicit indication of one or more of antenna groups to be used for transmission of the scheduled transport blocks. A WTRU may be configured to determine the selected antenna group for transmission based on a configured DCI field, e.g., Ng_tx. A WTRU may select the transport block for transmission based on the content of Ng_tx, if configured. If Ng_tx may not be configured, both transport blocks may be transmitted.

NDI, RV, and CBGTI indicators may be employed for two codeword transmission. A WTRU may be configured to use, e.g., use single, NDI, RV and CBGTI indicators for two codeword transmission.

A WTRU may transmit a first PUSCH transmission with two CWs.

The WTRU may receive an UL grant DCI scheduling a second PUSCH transmission, where the UL grant may include one or more indications associated with each of two CWs and where an indication may be an NDI, an RV, and/or a CBGTI.

The WTRU may determine whether to retransmit the first and/or second CW based on at least an (e.g., one) NDI included in the DCI. If the NDI may be toggled (e.g., compared to a last grant received for the same HARQ process), the WTRU may determine that the TBs mapped to both CWs of the first transmission were received successfully and to transmit new data for both CWs. If the NDI may not be toggled, the WTRU may determine (e.g., may interpret that as an indication) to retransmit the CW with a lower MCS (e.g., the lower MCS used for the first PUSCH transmission or the lower MCS indicated in the DCI for the second PUSCH transmission). If the NDI may not be toggled, the WTRU may determine whether to retransmit the second CW based on a combination of one or more other received indications in the DCI, e.g., a combination of one or more of RV, CBGTI, or others.

The WTRU may, e.g., may optionally, interpret a received RV according to a dynamic or semi-static configuration in which a table may be configured where each received RV index in the DCI points to a pair of RV values, corresponding to the first and second codewords. For retransmission of a single codeword, the first value, e.g., only the first value, of the indicated pair may be used.

If retransmission may be determined for at least one CW, the WTRU may retransmit a TB mapped to each of the CWs determined to be retransmitted. The WTRU may retransmit codeblocks (e.g., for one or both CWs) based on the CBGTI.

If new data transmission may be determined for at least one CW, the WTRU may transmit a new TB mapped to each CW for which it was determined to transmit new data.

For an 8TX WTRU scheduled for transmission with two codewords, if additional bit fields for the second codeword may not be configured, one or more of the following may be used for indication of NDI, RV and CBGTI: WTRU behavior 1; WTRU behavior 2; and/or WTRU behavior 3.

With respect to WTRU behavior 1, if the WTRU receives a DCI containing a single bit NDI field, it may determine the success or failure of transmission related to both codewords. In other words, toggling of the NDI bit may require successful decoding of both codewords. For example, A toggled NDI bit may be interpreted as successful decoding of transmissions related to both codewords, and a non-toggled NDI bit may trigger re-transmission for both codewords.

With respect to WTRU behavior 2, if the WTRU receives a DCI containing a single bit RV field, it may determine the RV associated with each re-transmission according to a preconfigured set. For example, if one, e.g., only one, of the CWs may be re-transmitted, assuming availability of separate NDI fields, the re-transmission may use the RV value as indicated. If both CWs are to be re-transmitted, the indicated RV value may be used as an index to a pre-configured table where each indicated value may correspond to a pair of RV values.

With respect to WTRU behavior 3, if the WTRU receives a DCI containing a single CBGTI field, it may re-transmit the CBGs of both codewords according to the indicated CBGTI. An uplink scheduling DCI, e.g., DCI format 0_1, may include multiple fields related to HARQ signaling, namely, RV, NDI, CBGTI, etc., where, RV field may indicate the RV related to the scheduled (re-) transmission, NDI field may indicate whether the scheduled transmission may relate to a re-transmission or a new transmission, and CBGTI field may indicate the code blocks for re-transmission if code block group transmission (CBG) may be configured.

A WTRU may be configured with bit fields, e.g., additional bit fields. For a WTRU scheduled for transmission with two codewords, e.g., an 8TX WTRU, additional bit fields may be considered for one or more of MCS, RV, NDI, CBGTI, or other related indications. A WTRU may implicitly determine if additional fields or extension of the existing fields may be configured in the scheduling DCI based on another system operation parameter, e.g., the received indicated rank or precoding information.

A WTRU may receive a first dynamic or semi-static indication of the transmission rank. If the received indicated rank exceeds a threshold, e.g., more than 4 layers, the WTRU may begin assuming that all future transmissions beyond a time reference are based on using more than one codeword. Such an indication may be considered as an activation command for transmission with more than one codewords.

The WTRU may assume all received scheduling DCI have at least one additional field or an extended field to indicate information related to the second codewords, e.g., one or more of MCS, RV, NDI, CBGTI, or other related indications.

A WTRU may continue assuming future transmissions based on more than one codeworks until it receives an explicit or implicit indication to reverse the assumption. A WTRU may assume, e.g., may alternatively assume, the duration for validity of transmission with more than one codeword, e.g., only, for a limited duration, where the duration may be fixed, preconfigured, or indicated as part of the initial activation command.

A WTRU may be configured to re-use the existing DCI fields. For a WTRU scheduled for transmission with two codewords, additional bit fields may or may not be configured for indication of at least one or more of MCS, RV, NDI, CBGTI, or other related indications for the support of the second codeword. A WTRU may interpret the state of transmission for the second codeword according to the existing bit fields for single codeword operation.

A WTRU may implicitly determine whether more than one codeword may be scheduled for transmission based on another system operation parameter, e.g., the received indicated rank or precoding information.

A WTRU may receive a first dynamic or semi-static indication of the transmission rank. If the received indicated rank may exceed a threshold, e.g., more than 4 layers, the WTRU may begin assuming that all future transmissions beyond a time reference are based on using more than one codeword. Such an indication may be considered as an activation command for transmission with more than one codewords.

The WTRU may begin interpreting the received DCI accordingly, that is, interpreting the existing bitfields for single codeword operation for the case of transmission with more than one codeword.

A WTRU may continue assuming future transmissions based on more than one codewords until it receives an explicit or implicit indication to reverse the assumption. A WTRU may assume, e.g., alternatively may assume, the duration for validity of transmission with more than one codeword, e.g., only, for a limited duration, where the duration may be fixed, preconfigured, or indicated as part of the initial activation command.

For a WTRU scheduled for transmission with two codewords, if additional bit fields for NDI, RV and CBGTI for support of the second codeword may not be configured, the WTRU may use one or more of the following to determines whether to retransmit the first and/or second CW based on at least an (e.g., one) NDI included in the scheduling DCI.

If a WTRU may receive a scheduling DCI containing a single bit NDI field, it may interpret the received NDI indication for the state of transmission of both codewords. A WTRU may determine the success or failure of an earlier transmission of both codewords using the same indicated NDI. A toggled NDI bit may be interpreted as successful decoding of transmissions related to both codewords and a non-toggled NDI bit may trigger re-transmission for both codewords even if the WTRU may fail in successful decoding of one, e.g., only one, of the codewords.

If a WTRU may receive a scheduling DCI containing a single bit NDI field, the received NDI indication may be associated with the state of the decoding of the codeword with a lower MCS. The WTRU may consider at least one of the following exemplary interpretations to determine whether to retransmit the first and/or second CW based on at least whether the NDI is toggled or not toggled.

If NDI may be toggled, a WTRU may assume that the codeword associated with the lower MCS may be decoded successfully. The WTRU may also assume successful decoding of the codeword with higher MCS. A WTRU may determine whether the decoding of the second codeword has been successful based on a specific combination of received indications in the DCI, e.g., a specific combination of one or more of RV, CBGTI, etc.

If NDI may not be toggled, the codeword associated with the lower MCS may not be decoded successfully. A WTRU may also assume failure in decoding of the codeword with higher MCS.

In examples where the received NDI indication, e.g., NDI bit, may be associated with the state of the decoding of the codeword with a lower MCS, some of the other received indications, e.g., RV, CBGTI, etc. may also be related to the codeword with the lower MCS.

If a WTRU may receive a scheduling DCI containing a single RV field, the received RV indication, e.g., RV bit field in the DCI, a WTRU may consider at least one of the following exemplary interpretations. If one, e.g., only one, of the CWs needs to be re-transmitted, the re-transmission may use the RV value as indicated. The determination of which codeword to be retransmitted may be based on having separate NDI indications, or it may be based on another implementation based on use of a single NDI indication.

A WTRU may receive a dynamic or semi-static configuration in which a table may be configured where each received RV index in the DCI points to a pair of RV values corresponding to the first and second codewords. If both codewords may be re-transmitted, the indicated RV value may be used as an index to the pre-configured table to determine the pair of RV values required for retransmission.

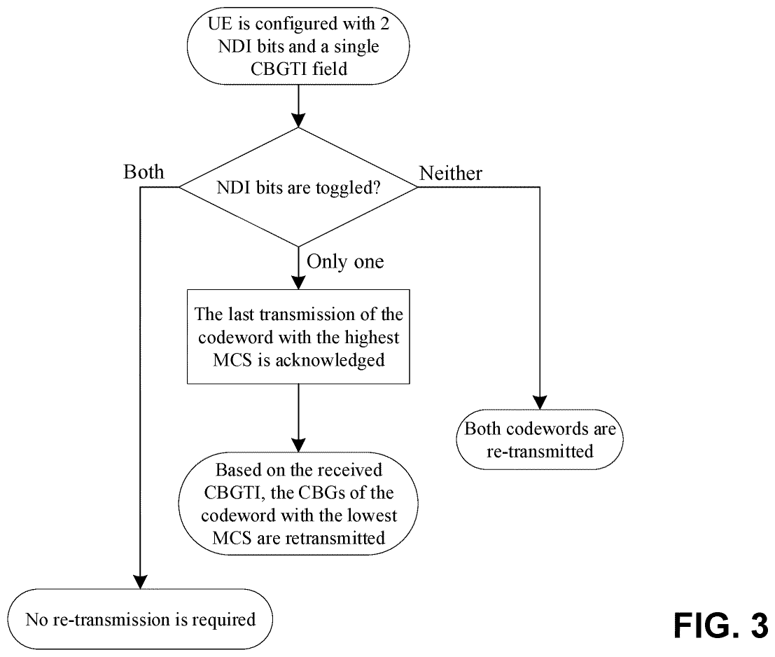

A WTRU may be configured to support code block group-based transmissions by receiving a higher layer parameter. If a WTRU receives a DCI including a CBGTI field, a bit value of ‘0’ in the CBGTI field may indicate that the corresponding CBG may/may not be transmitted and ‘1’ may indicate that it is to be transmitted. The CBGTI field may be configured with a length of 0, 2, 4, 6, or 8 bits. If a WTRU receives a scheduling DCI containing a single CBGTI indication, e.g., a single CBGTI field in the DCI, a WTRU may consider at least one of the following exemplary interpretations. If one, e.g., only one, of the CWs needs to be re-transmitted, the re-transmission may use the indicated CBGTI value. The determination of which codeword to be retransmitted may be based on having separate NDI indications, or it may be based on another implementation based on use of a single NDI indication. A WTRU may interpret the received CBGTI as an indication of retransmission for the codeword with the lower MCS. FIG. 3 shows an example ACK mechanism for two codeword transmission that may rely on a single CBGTI field.

If a WTRU may receive a scheduling DCI containing a single CBGTI field, it may interpret the received CBGTI as an indication applicable for re-transmission of both codewords. A WTRU may interpret each bit in the received CBGTI field as an indication that the corresponding codeblocks of both codewords may be retransmitted. A ‘0’ bit in the nth position of the received CBGTI field may require the WTRU to re-transmit the nth codeblock of both code words.

A WTRU may be configured with a length M CBGTI field. If the WTRU may be scheduled for transmission with two codewords, it may interpret the CBGTI field as two indications for M/2 number of codeblocks for each codeword. If the CBGTI field may be configured with 8 bits, a WTRU may assume that there may be 4 codeblock groups per codeword. The first and second 4 bits may reflect a retransmission requirement for the first and second codewords.

Although features and elements described herein are described in particular combinations, each feature or element may be used alone without the other features and elements of the preferred embodiments, or in various combinations with or without other features and elements.

The description herein may be provided for exemplary purposes and does not limit in any way the applicability of the described systems, methods, and instrumentalities to other wireless technologies and/or to wireless technology using different principles, when applicable. The term network in this disclosure may refer to one or more gNBs which in turn may be associated with one or more Transmission/Reception Points (TRPs) or any other node in the radio access network.

Although the implementations described herein may consider 3GPP specific protocols, it is understood that the implementations described herein are not restricted to this scenario and may be applicable to other wireless systems. For example, although the implementations described herein consider LTE, LTE-A, New Radio (NR) or 5G specific protocols, it is understood that the implementations described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit and receive unit (WTRU), comprising:
a processor configured to:
receive downlink control information (DCI) associated with an uplink (UL) grant for an UL transmission, the DCI comprising one or more indicators associated with at least one of a first codeword and a second codeword, the one or more indicators comprising at least one of a transmission precoding matrix indicator (TPMI) associated with the first codeword or an antenna-group indicator;
determine, based on at least the TPMI associated with the first codeword, the first codeword is enabled for transmission and the second codeword is disabled for transmission; and
transmit a transport block associated with the first codeword.

22. The WTRU of claim 21, wherein the one or more indicators further comprise at least one of a new data indicator (NDI), a redundancy version (RV), a modulation and coding scheme (MCS), or a HARQ-ID.

23. The WTRU of claim 21,
wherein the one or more indicators associated with at least one of the first codeword and the second codeword further comprises a second TPMI associated with the second codeword; and
wherein the processor configured to determine, based on at least the TPMI associated with the first codeword, the first codeword is enabled for transmission and the second codeword is disabled for transmission is further configured to determine, based on at least the TPMI associated with the first codeword and the second TPMI associated with the second codeword, the first codeword is enabled for transmission and the second codeword is disabled for transmission.

24. The WTRU of claim 23,
wherein the second TPMI associated with the second codeword is associated with an antenna selection precoder.

25. The WTRU of claim 23,
wherein the second TPMI associated with the second codeword indicates at least one of a null value, a reserved value, or a defined state.

26. The WTRU of claim 21,
wherein the TPMI associated with the first codeword comprises a range of TPMI.

27. The WTRU of claim 21,
wherein the one or more indicators comprising at least one of the TPMI associated with the first codeword or the antenna-group indicator comprise a first antenna-group indicator associated with the first codeword,
wherein the processor configured to determine, based on at least the TPMI associated with the first codeword, the first codeword is enabled for transmission and the second codeword is disabled for transmission is further configured to determine, based on at least the TPMI associated with the first codeword and the first antenna-group indicator, the first codeword is enabled for transmission and the second codeword is disabled for transmission.

28. The WTRU of claim 21,
wherein the processor is further configured to:
receive second DCI associated with a second UL grant for a second UL transmission, the second DCI comprising one or more indicators associated with at least one of a third codeword and a fourth codeword, the one or more indicators comprising at least a third TPMI associated with the third codeword and a fourth TPMI associated with the fourth codeword; and
determine, based on at least the third TPMI and the fourth TPMI, the third codeword is enabled for transmission and the fourth codeword is enabled for transmission.

29. A method comprising:
receiving downlink control information (DCI) associated with an uplink (UL) grant for an UL transmission, the DCI comprising one or more indicators associated with at least one of a first codeword and a second codeword, the one or more indicators comprising at least one of a transmission precoding matrix indicator (TPMI) associated with the first codeword or an antenna-group indicator;
determining, based on at least the TPMI associated with the first codeword, the first codeword is enabled for transmission and the second codeword is disabled for transmission; and
transmitting a transport block associated with the first codeword.

30. The method of claim 29, wherein the one or more indicators further comprise at least one of a new data indicator (NDI), a redundancy version (RV), a modulation and coding scheme (MCS), or a HARQ-ID.

31. The method of claim 29,
wherein the one or more indicators associated with at least one of the first codeword and the second codeword further comprises a second TPMI associated with the second codeword; and
wherein determining, based on at least the TPMI associated with the first codeword, the first codeword is enabled for transmission and the second codeword is disabled for transmission comprises determining, based on at least the TPMI associated with the first codeword and the second TPMI associated with the second codeword, the first codeword is enabled for transmission and the second codeword is disabled for transmission.

32. The method of claim 31,
wherein the second TPMI associated with the second codeword is associated with an antenna selection precoder.

33. The method of claim 31,
wherein the second TPMI associated with the second codeword indicates at least one of a null value, a reserved value, or a defined state.

34. The method of claim 29,
wherein the TPMI associated with the first codeword comprises a range of TPMI.

35. The method of claim 29,
wherein the one or more indicators comprising at least one of the TPMI associated with the first codeword or the antenna-group indicator comprise a first antenna-group indicator associated with the first codeword,
wherein determining, based on at least the TPMI associated with the first codeword, the first codeword is enabled for transmission and the second codeword is disabled for transmission comprises determining, based on at least the TPMI associated with the first codeword and the first antenna-group indicator, the first codeword is enabled for transmission and the second codeword is disabled for transmission.

36. The method of claim 35, further comprising:
receiving second DCI associated with a second UL grant for a second UL transmission, the second DCI comprising one or more indicators associated with at least one of a third codeword and a fourth codeword, the one or more indicators comprising at least a third TPMI associated with the third codeword and a fourth TPMI associated with the fourth codeword; and
determining, based on at least the third TPMI and the fourth TPMI, the third codeword is enabled for transmission and the fourth codeword is enabled for transmission.

37. A wireless transmit and receive unit (WTRU), comprising:
a processor configured to:
receive one or more indicators associated with an uplink (UL) grant for an UL transmission, the one or more indicators associated with at least one of a first codeword and a second codeword, and the one or more indicators comprising at least one of a transmission precoding matrix indicator (TPMI) associated with first codeword or an antenna-group indicator;
determine, based on at least the TPMI associated with the first codeword, the first codeword is enabled for transmission and the second codeword is disabled for transmission; and
transmit a transport block associated with the first codeword.

38. The WTRU of claim 37,
wherein the one or more indicators comprising at least one of a TPMI associated with the first codeword or the antenna-group indicator further comprises a second TPMI associated with the second codeword,
wherein the processor configured to determine, based on at least the TPMI associated with the first codeword, the first codeword is enabled for transmission and the second codeword is disabled for transmission is further configured to determine, based on at least the TPMI associated with the first codeword and the second TPMI associated with the second codeword, the first codeword is enabled for transmission and the second codeword is disabled for transmission, and
wherein the second TPMI is one of a null value, a reserved value, or a defined state.

39. The WTRU of claim 37,
wherein the TPMI associated with the first codeword has an associated structure,
wherein the processor configured to determine, based on at least the TPMI associated with the first codeword, the first codeword is enabled for transmission and the second codeword is disabled for transmission is further configured to determine, based on the associated structure, the first codeword is enabled for transmission and the second codeword is disabled for transmission.

40. The WTRU of claim 37,
wherein the one or more indicators comprising at least one of the TPMI associated with the first codeword or the antenna-group indicator comprise a first antenna-group indicator associated with the first codeword,
wherein the processor configured to determine, based on at least the TPMI associated with the first codeword, the first codeword is enabled for transmission and the second codeword is disabled for transmission is further configured to determine, based on at least the TPMI associated with the first codeword and the first antenna-group indicator, the first codeword is enabled.
